(19) United States
(12) Patent Application Publication
(10) Pub. No.: US 2011/0165465 A1
(43) Pub. Date: Jul. 7, 2011

(54) Negative active material for rechargeable lithium battery, method of preparing same, and rechargeable lithium battery including same

(75) Inventors: Tae-Keun Kim, Yongin-si (KR); Jun-Sik Kim, Yongin-si (KR); Jin-Kyu Hong, Yongin-si (KR); Sae-Weon Roh, Yongin-si (KR); Man-Seok Han, Yongin-si (KR); Sung-Soo Kim, Yongin-si (KR); Eui-Hwan Song, Yongin-si (KR)

(73) Assignee: Samsung SDI Co., Ltd., Yongin-si (KR)

(21) Appl. No.: 12/805,857

(22) Filed: Aug. 20, 2010

(30) Foreign Application Priority Data
Jan. 7, 2010 (KR) 10-2010-0001240

(51) Int. Cl. H01M 4/58; H01M 4/88

(52) U.S. Cl. 429/231.5; 252/182.1

(57) ABSTRACT

A negative active material for a rechargeable lithium battery, a method of preparing the negative active material, and a rechargeable lithium battery including the negative active material. The negative active material has a composite of an active material and crystalline carbon. The active material includes a core and a carbon coating layer formed on the core and including amorphous carbon. The core includes a compound represented by a Chemical Formula LixTiyO₄, wherein 0.6≦x≦2.5, and 1.2≦y≦2.3.

### CLAIM OF PRIORITY

This application makes reference to, incorporates into this specification the entire contents of, and claims all benefits accruing under 35 U.S.C. §119 from an application earlier filed in the Korean Intellectual Property Office filed on Jan. 7, 2010, and there duly assigned Serial No. 10-2010-0001240.

### BACKGROUND OF THE INVENTION

1. Field of the Invention

This disclosure relates to a negative active material for a rechargeable lithium battery, a method of preparing the same, and a rechargeable lithium battery including the same.

2. Description of the Related Art

Lithium rechargeable batteries recently have drawn attention as a power source of small portable electronic devices. Lithium rechargeable batteries use an organic electrolyte solution, and thereby have twice the discharge voltage of a conventional battery using an alkali aqueous solution, and, as a result, provide high energy density.

### SUMMARY OF THE INVENTION

One aspect of this disclosure provides an improved negative active material and an improved rechargeable lithium battery.

Another aspect of this disclosure provides a negative active material for a rechargeable lithium battery having excellent conductivity.

Still another aspect of this disclosure provides a method of preparing the negative active material.

A Further aspect of this disclosure provides a rechargeable lithium battery including the negative active material.

According to one aspect of this disclosure, a negative active material for a rechargeable lithium battery is provided that includes a composite of an active-material and a crystalline carbon. The active-material includes a core and a carbon coating layer. The core includes a compound represented by a Chemical Formula LiₓTi_{y}O₄, wherein 0.6≦x≦2.5, 1.2≦y≦2.3. The carbon coating layer includes amorphous carbon.

The crystalline carbon may be fiber-type and for example, may include carbon nanotube (CNT), a carbon nano fiber (CNF), a vapor-grown carbon fiber (VGCF), or a combination thereof.

The amorphous carbon may be included in an amount of about 0.1 wt % to about 2 wt % based on the weight of a compound represented by the above Chemical Formula. The crystalline carbon may be included in an amount of about 1 wt % to about 20 wt % based on the entire weight of a negative active material.

Herein, the negative active material may include the amorphous carbon and the crystalline carbon in a weight ratio ranging from about 1:99 to about 30:70.

The coating layer may be about 1 nm to about 20 nm thick.

According to another aspect of this disclosure, a method of preparing a negative active material for a rechargeable lithium battery is provided that includes preparing an amorphous carbon precursor liquid by adding an amorphous carbon precursor to a solvent, adding crystalline carbon and a compound represented by the above Chemical Formula to the amorphous carbon precursor liquid, and heat-treating the mixture.

The amorphous carbon precursor may be citric acid, sucrose, cooking oil, cellulose acetate, polyacrylonitrile, polystyrene, phenol resin, naphthalenes, or a combination thereof.

The heat treatment may be performed at a temperature ranging from about 650° C. to about 750° C.

According to still another aspect of this disclosure, a rechargeable lithium battery is provided that includes a negative electrode including the negative active material, a positive electrode including a positive active material, and a non-aqueous electrolyte.

The negative active material constructed as one embodiment according to the principles of the present invention has excellent output characteristics and energy density.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a drawing comprehensively showing a negative active material constructed as one embodiment according to the principles of the present invention;

FIG. 2 is a schematic view of a rechargeable lithium battery constructed as one embodiment according to the principles of the present invention;

FIG. 3 is a SEM photograph of the negative active material constructed as Example 1 according to the principles of the present invention;

FIG. 4 is a TEM photograph of the negative active material constructed as Example 1 according to the principles of the present invention;

FIG. 5 is a SEM photograph enlarging the SEM photograph provided in FIG. 3;

FIG. 6 is a graph illustrating discharge results of the negative active material constructed as Example 1 according to the principles of the present invention; and

FIG. 7 is a graph showing the discharge result of a negative active material constructed as Comparative Example 1.

### DETAILED DESCRIPTION OF THE INVENTION

As for positive active materials for a rechargeable lithium battery, consideration has been given to lithium-transition element composite oxides being capable of intercalating lithium ions such as LiCoO₂, LiMn₂O₄, LiNi₁₋ₓCoₓO₂ (0<x<1).

As for negative active materials for a rechargeable lithium battery, various carbon-based materials such as artificial graphite, natural graphite, and hard carbon, all of which can intercalate and deintercalate lithium ions, have been used. Since graphite among the carbon-based materials has a low discharge potential of −0.2V relative to lithium, a battery using the graphite as a negative active material has a high discharge potential of 3.6V and excellent energy density. Furthermore, graphite guarantees a long cycle life for a battery due to its outstanding reversibility. A graphite active material, however, has a low density (theoretical density of 2.2 g/cc) and consequently a low capacity in terms of energy density per unit volume when the graphite is used as a negative active material. Further, the graphite active material involves swelling and a capacity reduction problem when a battery is misused or overcharged and the like, because graphite is likely to react with an organic electrolyte at a high discharge voltage.

In addition, there has been an attempt to use lithium titanate as a negative electrode material. Since lithium titanate has a voltage of 1.5 V based on a lithium metal, a long cycle-life, and a higher operation voltage than reduction potential of lithium, lithium titanate has the merit of preventing lithium extraction on the surface of a negative electrode when overcharged. Accordingly, lithium titanate should be considered to as an active material for a large capacity battery.

In particular, Li₄Ti₅O₁₂ having a Spinel structure is known to have small crystal structure change and little degradation across charge and discharge cycles when Li₄Ti₅O₁₂ repetitively intercalates/deintercalates lithium as the useful negative active material. Li₄Ti₅O₁₂ has low electric conductivity (˜10⁻⁹ S/cm); Li₄Ti₅O₁₂ has, however, a problem of high reaction resistance during the intercalation/deintercalation of lithium and remarkable characteristic deterioration of sharp charge/discharge. Thus, a Li₄Ti₅O₁₂ may not be used for a battery requiring high power.

Accordingly, in order to improve conductivity of the lithium titanate, lithium titanate should be physically mixed with a carbon material such as carbon black and the like. Since the carbon material is added in a large amount in order to form an adequate electrically conductive network, a negative active material that includes less lithium titanate as much as carbon material is added and thus, causes a problem of deteriorating energy density during successive operational cycles of the battery.

Exemplary embodiments will hereinafter be described in detail. It should be noted, however, that these embodiments are exemplary, and this disclosure is not limited thereto.

One embodiment generally relates to a Spinel-type lithium-titanium-based negative active material.

The negative active material includes a composite including an active-material and a crystalline carbon. The active-material includes a core constructed with a compound represented by the following Chemical Formula 1 and a carbon coating layer formed on the core and including amorphous carbon.

LiₓTi_{y}O₄ [Chemical Formula 1]

In the Chemical Formula 1, 0.6≦x≦2.5, and 1.2≦y≦2.3.

Examples of the compound represented by the above Chemical Formula 1 may include Li₄Ti₅O₁₂, LiTi₂O₄, Li_{1.33}Ti_{1.66}O₄, Li_{0.8}Ti_{2.2}O₄, and the like. Among the compounds represented by the above Chemical Formula 1, Li₄Ti₅O₁₂ has a Li ratio of 1 and a Ti ratio of about 1.67 when O has a mole ratio of 4.

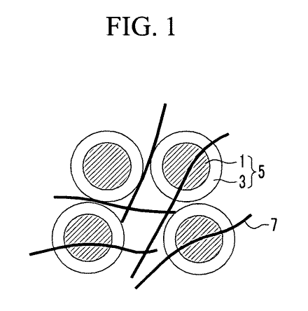

FIG. 1 shows a schematic structure of the negative active material. As shown in FIG. 1, the negative active material consists of a composite including an active-material 5, and crystalline carbon 7. Active-material 5 includes a core 1 and a carbon coating layer 3 formed on core 1. Carbon coating layer 3 includes amorphous carbon. In other words, the crystalline carbon 7 exists among a plurality of active materials 5 as a fiber. In addition, the active-materials and the crystalline carbon may be physically coagulated together. In other words, the active-material and the crystalline carbon may rather not be simply mixed.

The crystalline carbon may be fiber-type and for example, may include a carbon nanotube, a carbon nano fiber, a vapor-grown carbon fiber, or a combination thereof. The fiber-type crystalline carbon may have better electric conductivity than the non-fiber-type one. Even the fiber-type crystalline carbon may have difficulty in being fabricated into a metal. Even when the fiber-type crystalline carbon is fabricated into a metal, the fiber-type crystalline carbon may pierce a separator, and bring about a short cut when applied to a battery.

The crystalline carbon may be included in an amount of 1 wt % to 20 wt % based on the entire weight of the negative active material. When included within the range, the negative active material may maintain appropriate energy density and develop an adequate network through which electrons may move due to fiber-type crystalline carbon, and economically increase electric conductivity.

The amorphous carbon included in the carbon coating layer indicates carbon with no sharp peak when measured regarding XRD using CuKα. In particular, the amorphous carbon is formed by heat-treating an amorphous carbon precursor at a temperature ranging from about 650° C. to 750° C. The amorphous carbon may have properties similar to hard carbon. The sharp peak indicates a peak shown in crystalline carbon, which is easily understood in a related field.

According to one embodiment, the amorphous carbon may be included in an amount ranging from about 0.1 wt % to about 2 wt % based on the compound represented by the above Chemical Formula 1 in the negative active material. When the amorphous carbon is included within the range, the amorphous carbon may sufficiently cover the compound represented by the above Chemical Formula 1, to enable electrons to smoothly move around without deterioration of electric conductivity.

The carbon coating layer may be about 1 nm to about 20 nm thick. When the carbon coating layer has a thickness within that range, the carbon coating layer may not prevent lithium ions from moving, but will assure an uniform coating of lithium titanate and, as a result, will not deteriorate the electric conductivity.

Herein, the amorphous carbon and the crystalline carbon may be included in a weight ratio of about 1:99 to about 30:70 in the negative active material. In another embodiment, they may be included in a weight ratio of about 5:95 to about 15:85. In other words, when the crystalline carbon is included excessively more than the amorphous carbon, it may more effectively secure higher electric conductivity.

The amorphous carbon may act as a binder. The crystalline carbon provides an excellent conductive network among compound particles represented by Chemical Formula 1, and between the compound represented by Chemical Formula 1 and a current collector, and thereby improves conductivity of the compound represented by the Chemical Formula 1, resultantly improving output characteristic of a battery formed of the crystalline carbon. Accordingly, the crystalline carbon would be better to be excessively more used than the amorphous carbon. In addition, a negative active material may be relatively more used instead of less using a conductive material to prepare negative active material slurry due to improved conductive network, thus improving energy density of a battery.

Another embodiment provides a method of preparing a negative active material for a rechargeable lithium battery. The method includes a process of preparing an amorphous carbon precursor liquid by adding an amorphous carbon precursor to a solvent, adding crystalline carbon and a compound represented by the following Chemical Formula 1 to the amorphous carbon precursor liquid, and heat-treating the mixture.

LiₓTi_{y}O_{Z} [Chemical Formula 1]

In Chemical Formula 1, 0.6≦x≦2.5, and 1.2≦y≦2.3.

Hereinafter, the method according to one embodiment will be illustrated in detail.

First of all, the amorphous carbon precursor liquid is prepared by adding the amorphous carbon precursor to the solvent. The amorphous carbon precursor may include citric acid, sucrose, cooking oil, cellulose acetate, polyacrylonitrile, polystyrene, phenol resin, naphthalenes, or a combination thereof. The solvent may include an organic solvent such as methanol, ethanol, isopropanol, distilled water, N-methylpyrrolidone, dimethyl formamide, or a combination thereof.

The amorphous carbon precursor liquid may have a concentration ranging from about 1 wt % to about 30 wt %.

Next, crystalline carbon and the compound represented by the following Chemical Formula 1 are added to the amorphous carbon precursor liquid. The crystalline carbon may be fiber-type and for example, includes carbon nanotube, a carbon nano fiber, a vapor-grown carbon fiber, or a combination thereof.

LiₓTi_{y}O_{Z} [Chemical Formula 1]

In Chemical Formula 1, 0.6≦x≦2.5, and 1.2≦y≦2.3.

The crystalline carbon, the compound represented by the above Chemical Formula 1, and the amorphous carbon precursor liquid are mixed in a weight ratio ranging from about 0.25:5:1 to about 9:300:1.

Then, the mixture is heat-treated. The heat treatment may be performed at a temperature ranging from 650° C. to 750° C., but in another embodiment, from about 675° C. to about 725° C. The heat treatment is performed under N₂ atmosphere for about 60 minutes to about 120 minutes. When performed under these conditions, lithium titanate particles may not be agglomerated together but instead form a carbon coating layer with appropriate electrical conductivity.

According to the heat treatment process, the amorphous carbon precursor is converted into amorphous carbon and forms a carbon coating layer surrounding the surface of the compound represented by the above Chemical Formula 1. Since the crystalline carbon maintains the state and exists physically as coagulated with the active-material around the compound represented by the above Chemical Formula 1, the crystalline carbon forms a composite with the active material. Accordingly, the crystalline carbon may form an excellent electrically conductive network.

Another embodiment provides a rechargeable lithium battery.

Rechargeable lithium batteries may be classified as lithium ion batteries, lithium ion polymer batteries, and lithium polymer batteries according to the presence of a separator and the kind of electrolyte used in the battery. The rechargeable lithium batteries may have a variety of shapes and sizes, and include cylindrical, prismatic, or coin-type batteries, and may be thin film batteries or may be rather bulky in size. Structures and fabricating methods for lithium ion batteries are well known in the art.

The rechargeable lithium battery may be fabricated with a negative electrode including a negative active material constructed as one embodiment according to the principles of the present invention, a positive electrode including a positive active material, and a non-aqueous electrolyte.

The negative electrode includes a negative current collector and a negative active material layer formed on the current collector. The negative active material layer includes the negative active material constructed as one embodiment according to the principles of the present invention.

The negative active material layer also includes a binder and selectively an electrical conductive material.

The binder improves binding properties of the negative active material particles to one another and to the current collector. The binder includes polyvinylalcohol carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but is not limited thereto.

The conductive material is used to endow an electrode with electrical conductivity and may include any electronic conductive material, unless the conductive material does not cause any chemical change in the battery. Examples of the conductive material include carbon-based materials such as natural graphite, artificial graphite, carbon black, acetylene black, ketjen black, a carbon fiber, and the like, metal-based materials such as metal powders or metal fibers of copper, nickel, aluminum, silver, and the like, conductive polymers such as polyphenylene derivatives, or mixtures thereof.

The negative current collector may be selected from the group consisting of a copper foil, a nickel foil, a stainless steel foil, a titanium foil, a nickel foam, a copper foam, a polymer substrate coated with an electrically conductive metal, and combinations thereof.

The positive electrode includes a positive current collector and a positive active material layer disposed on the current collector. The positive active material includes lithiated intercalation compounds that reversibly intercalate and deintercalate lithium ions. The positive active material may include a composite oxide including at least one material selected from the group consisting of cobalt, manganese, and nickel, as well as lithium. In particular, the following lithium-containing compounds may be used as the lithiated intercalation compounds:

LiₐA_{1-b}X_{b}D₂ (0.90≦a≦1.8, 0≦b≦0.5); LiₐE_{1-b}X_{b}O_{2-c}D_{c} (0.90≦a≦1.8, 0≦b≦0.5, 0≦c≦0.05); LiE_{2-b}X_{b}O_{4-c}D_{c} (0≦b≦0.5, 0≦c≦0.05); LiₐNi_{1-b-c}CO_{b}X_{c}D_{α} (0.90≦a≦1.8, 0≦b≦0.5, 0≦c≦0.05, 0<α≦2); LiₐNi_{1-b-c}CO_{b}X_{c}O_{2-α}T_{α} (0.90≦a≦1.8, 0≦b≦0.5, 0≦c≦0.05, 0<α≦2); LiₐNi_{1-b-c}CO_{b}X_{c}O_{2-α}T₂ (0.90≦a≦1.8, 0≦b≦0.5, 0≦c≦0.05, 0<α<2); LiₐNi_{1-b-c}Mn_{b}X_{c}D_{α} (0.90≦a≦1.8, 0≦b≦0.5, 0≦c≦0.05, 0<α≦2); LiₐNi_{1-b-c}Mn_{b}X_{c}O₂₋₆₀ T_{α} (0.90≦a≦1.8, 0≦b≦0.5, 0≦c≦0.05, 0<α≦2); LiₐNi_{1-b-c}Mn_{b}X_{c}O_{2-α}T₂ (0.90≦a≦1.8, 0≦b≦0.5, 0≦c≦0.05, 0<α<2); LiₐNi_{b}E_{c}G_{d}O₂ (0.90≦a≦1.8, 0≦b≦0.9, 0≦c≦0.5, 0.001≦d≦0.1); LiₐNi_{b}CO_{c}Mn_{d}GₑO₂ (0.90≦a≦1.8, 0≦b≦0.9, 0≦c≦0.5, 0≦d≦0.5, 0.001≦e≦0.1); LiₐNiG_{b}O₂ (0.90≦a≦1.8, 0.001≦b≦0.1) LiₐCoG_{b}O₂ (0.90≦a≦1.8, 0.001≦b≦0.1); LiₐMnG_{b}O₂ (0.90≦a≦1.8, 0.001≦b≦0.1); LiₐMn₂G_{b}O₄ (0.90≦a≦1.8, 0.001≦b≦0.1); QO₂; QS₂; LiQS₂; V₂O₅; LiV₂O₅; LiZO₂; LiNiVO₄; Li_{(3-f)}J₂(PO₄)₃ (0≦f≦2); Li_{(3-f)}Fe₂(PO₄)₃ (0≦f≦2); LiFePO₄

In the above formulae, A is selected from the group consisting of Ni, Co, Mn, and a combination thereof; X is selected from the group consisting of Al, Ni, Co, Mn, Cr, Fe, Mg, Sr, V, a rare earth element, and a combination thereof; D is selected from the group consisting of O, F, S, P, and a combination thereof; E si selected from the group consisting of Co, Mn, and a 2:3 combination thereof; T is selected from the group consisting of F, S, P, and a combination thereof; G is selected from the group consisting of Al, Cr, Mn, Fe, Mg, La, Ce, Sr, V, and a combination thereof; Q is selected from the group consisting of Ti, Mo, Mn, and a combination thereof; Z is selected from the group consisting of Cr, V, Fe, Sc, Y, and a combination thereof; and J is selected from the group consisting of V, Cr, Mn, Co, Ni, Cu, and a combination thereof.

The lithiated intercalation compound may have a coating layer on the surface of the lithiated intercalation compound, or the lithiated intercalation compound may be used after being mixed with another compound bearing a coating layer thereon. The coating layer may include at least one coating element compound selected from the group of oxide and hydroxide of a coating element, oxyhydroxide of a coating element, oxycarbonate of a coating element, and hydroxycarbonate of a coating element, and a combination thereof. The coating element compound that forms the coating layer may be amorphous or crystalline. The coating element included in the coating layer may be at least one selected from the group of Mg, Al, Co, K, Na, Ca, Si, Ti, V, Sn, Ge, Ga, B, As, Zr, or a mixture of these elements. The coating layer may be formed of the aforementioned compounds and elements in any forming technique, as long as that technique preserves, and does not deleteriously alter the physical properties of the positive active material such as spray coating, impregnation, and the like. Since these techniques are generally understood by those skilled in the art to which this disclosure pertains, these techniques will not be described herein in detail.

The positive active material layer also includes a binder and a conductive material.

The binder improves binding properties of the positive active material particles to one another, and also with an electrical current collector. Examples of these binders include at least one selected from the group consisting of polyvinylalcohol, carboxylmethylcellulose, hydroxypropylcellulose, diacetylcellulose, polyvinyl chloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The electrically conductive material is included to improve electrode conductivity. Any electrically conductive material may be used as the conductive material unless the material causes a chemical change. Examples of acceptable electrically conductive materials include one or more of natural graphite, artificial graphite, carbon black, acetylene black, ketjen black, carbon fiber, a metal powder or a metal fiber including copper, nickel, aluminum, or silver, and polyphenylene derivatives.

The positive current collector may be Al, but the positive current collector is not limited thereto.

The positive electrode may be fabricated by a method such as a mixing of the positive active material, the conductive material and the binder in a solvent to provide a positive active material composition, and coating the positive current collector with the positive active material composition. The electrode manufacturing method is well-known and thus, need not be described in any greater detail in the present specification. The solvent may be N-methylpyrrolidone, water, and the like but it is not limited thereto.

The non-aqueous electrolyte includes a non-aqueous organic solvent and a lithium salt.

The non-aqueous organic solvent serves as a medium for transmitting ions taking part in the electrochemical reaction of the battery.

The non-aqueous organic solvent may include a carbonate-based, ester-based, ether-based, ketone-based, alcohol-based, or aprotic solvent. Examples of carbonate-based solvents may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. Examples of ester-based solvents may include methyl acetate, ethyl acetate, n-propyl acetate, dimethylacetate, methylpropionate, ethylpropionate, γ-butyrolactone, decanolide, valerolactone, mevalonolactone, caprolactone, and the like. Examples of ether-based solvents include dibutyl ether, tetraglyme, diglyme, dimethoxyethane, 2-methyltetrahydrofuran, tetrahydrofuran, and the like, and examples of ketone-based solvents include cyclohexanone, and the like. Examples of the alcohol-based solvent include ethyl alcohol, isopropyl alcohol, and the like, and examples of aprotic solvents include nitriles such as R—CN (wherein R is a C2 to C20 linear, branched, or cyclic hydrocarbon, a double bond, an aromatic ring, or an ether bond), amides such as dimethylformamide, dioxolanes such as 1,3-dioxolane, sulfolanes, and the like.

The non-aqueous organic solvent may be used singularly or in a mixture. When the organic solvent is used in a mixture, the mixture ratio may be controlled in accordance with a desirable battery performance.

The carbonate-based solvent may include a mixture of a cyclic carbonate and a linear carbonate. The cyclic carbonate and the chain carbonate (i.e., the linear carbonate) are mixed together in a volume ratio of about 1:1 to about 1:9. When the mixture is used as an electrolyte, the electrolyte performance may be enhanced.

In addition, non-aqueous organic solvents may further include mixtures of carbonate-based solvents and aromatic hydrocarbon-based organic solvents. The carbonate-based solvents and the aromatic hydrocarbon-based organic solvents may be mixed together in a volume ratio of about 1:1 to about 30:1.

The aromatic hydrocarbon-based organic solvents may be represented by the following Chemical Formula 2.

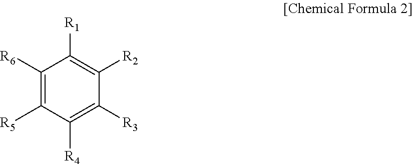

In the above Chemical Formula 2, R₁ through R₆ are independently hydrogen, a halogen, a C1 to C10 C alkyl, a C1 to C10 haloalkyl, or a combination thereof.

The aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The non-aqueous electrolyte may further include vinylene carbonate or an ethylene carbonate-based compound of the following Chemical Formula 3.

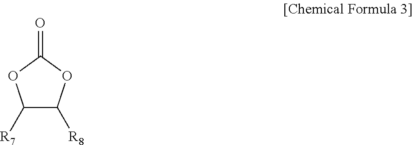

In the above Chemical Formula 3, R₇ and R₈ are independently hydrogen halogen, a cyano (CN), a nitro (NO₂), and a C1 to C5 fluoroalkyl, provided that at least one of R₇ and R₈ is a halogen, a nitro (NO₂), or a C1 to C5 fluoroalkyl, and R₇ and R₈ are not simultaneously hydrogen.

Examples of ethylene carbonate-based compounds include difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The amount of the additive used for improving cycle life may be adjusted within an appropriate range.

The lithium salt supplies lithium ions in the battery, thereby enabling a basic operation of a rechargeable lithium battery, and improves lithium ion transportation between positive and negative electrodes. Non-limiting examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, and LiB(C₂O₄)₂ (lithium bisoxalato borate, LiBOB). The lithium salt may be used in a concentration ranging from about 0.1 M to about 2.0 M. When the lithium salt is included within the above concentration range, electrolyte performance and lithium ion mobility may be enhanced due to optimal electrolyte conductivity and viscosity.

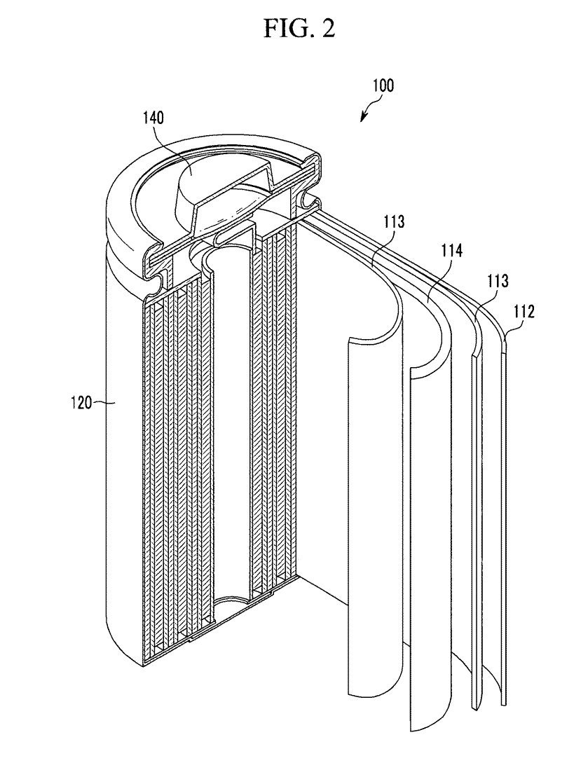

FIG. 2 is a schematic view of a representative structure of a rechargeable lithium battery. FIG. 2 illustrates a cylindrical rechargeable lithium battery 100, which includes a negative electrode 112, a positive electrode 114, a separator 113 interposed between negative electrode 112 and positive electrode 114, an electrolyte (not shown) impregnating separator 113, a battery case 120, and a sealing member 140 sealing battery case 120. Negative electrode 112, positive electrode 114, and separator 113 are sequentially stacked, spirally wound, and placed in a battery case 120 to fabricate rechargeable lithium battery 100.

Non-limiting examples of suitable separator materials include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The following examples illustrate this disclosure in more detail. These examples, however, are not in any sense to be interpreted as limiting the scope of this disclosure.

### Example 1

An amorphous carbon precursor liquid having 10 wt % of a concentration was prepared by adding a citric acid amorphous carbon precursor to ethanol.

Next, 9.2 wt % of the amorphous carbon precursor liquid was mixed with 8.3 wt % of carbon nanotubes and 82.5 wt % of a Li₄Ti₅O₁₂ compound.

The mixture was heat-treated under N₂ atmosphere at 700□ for 90 minutes, in order to prepare a negative active material. During the heat treatment process, the amorphous carbon precursor was converted into amorphous carbon and formed an amorphous carbon coating layer on the surface of the Li₄Ti₅O₁₂ compound, while the carbon nanotubes maintained their state and existed among the Li₄Ti₅O₁₂ compound particles forming the amorphous carbon coating layer. Accordingly, the prepared negative active material was a composite including an active-material including a Li₄Ti₅O₁₂ compound core and the amorphous carbon coating layer; and a crystalline carbon (carbon nanotubes). The carbon coating layer was 5 nm thick and included 0.5 wt % of the amorphous carbon based on the entire weight of the negative active material. The crystalline carbon was included in an amount of 4:5 wt % based on the entire weight of the negative active material. In addition, the amorphous carbon and the crystalline carbon were mixed in a weight ratio of 1:9.

The negative active material was mixed with a Ketjen black conductive material and a polyvinylidene fluoride binder in a ratio of 85:5:10 wt % in an N-methylpyrrolidone solvent, preparing negative active material slurry.

The negative active material slurry was coated on a Cu foil current collector and was compressed, thereby preparing a negative electrode.

The negative electrode was used together with a lithium metal as a counter electrode, an electrolyte solution, and a separator, to fabricate a lithium half-cell with a capacity of 2 mAh. The electrolyte solution was prepared by dissolving 1.15 mol/L of LiPF₆ in a mixed solvent prepared by mixing ethylenecarbonate, ethylmethylcarbonate, and dimethylcarbonate in a volume ratio of 3:3:4. The separator was a 20 μm-thick polyethylene porous film.

### Example 2

A citric acid amorphous carbon precursor was added to ethanol, to prepare an amorphous carbon precursor liquid having 10 wt % of a concentration.

1 wt % of the amorphous carbon precursor liquid was mixed with 1 wt % of carbon nanotubes and 98 wt % of a Li₄Ti₅O₁₂ compound.

The mixture was heat-treated under N₂ atmosphere at 700□ for 90 minutes, in order to prepare a negative active material. During the heat treatment process, the amorphous carbon precursor was converted into amorphous carbon and formed an amorphous carbon coating layer on the surface of a Li₄Ti₅O₁₂ compound, while the carbon nanotubes maintained their state and existed among those Li₄Ti₅O₁₂ compound particles forming the amorphous carbon coating layer. Accordingly, the prepared negative active material had a composite structure of an active-material including a Li₄Ti₅O₁₂ compound core and an amorphous carbon coating layer and of a crystalline carbon (e.g. carbon nanotubes). The carbon coating layer was 1 nm thick and included the amorphous carbon in an amount of 0.1 wt % and the crystalline carbon in an amount of 1 wt % based on the entire weight of a negative active material. In addition, the amorphous carbon and the crystalline carbon were mixed in a weight ratio of 1:9.

The negative electrode was used to fabricate a lithium half-cell according to the same method as Example 1.

### Example 3

An amorphous carbon precursor liquid having 10 wt % of a concentration was prepared by adding a cellulose acetate amorphous carbon precursor to ethanol.

9.2 wt % of the amorphous carbon precursor liquid was mixed with 8.3 wt % of carbon nanotubes and 82.5 wt % of a Li₄Ti₅O₁₂ compound.

The mixture was heat-treated at 700□ for 90 minutes under N2 atmosphere, in order to prepare a negative active material. During the heat treatment process, the amorphous carbon precursor was converted into amorphous carbon and formed an amorphous carbon coating layer on the surface of a Li₄Ti₅O₁₂ compound, while the carbon nanotubes maintained their state and existed among Li₄Ti₅O₁2 compound particles forming the amorphous carbon coating layer. Accordingly, the prepared negative active material had a composite structure of an active-material including a Li₄Ti₅O₁₂ compound core and an amorphous carbon coating layer and of crystalline carbon (carbon nanotube). The carbon coating layer was 5 nm thick and included 0.5 wt % of the amorphous carbon and 4.5 wt % of crystalline carbon based on the entire weight of a negative active material. In addition, the amorphous carbon and the crystalline carbon were mixed in a weight ratio of 1:9.

The negative electrode was used to fabricate a lithium half-cell according to the same method as described for Example 1.

### Comparative Example 1

A lithium half-cell was fabricated according to the same method as Example 1 except for the preparation of negative active material slurry by mixing a Li₄Ti₅O₁₂ negative active material, a carbon black conductive material, and polyvinylidene fluoride in a ratio of 85:5:10 wt % in an N-methylpyrrolidone solvent.

### SEM and TEM Photographs

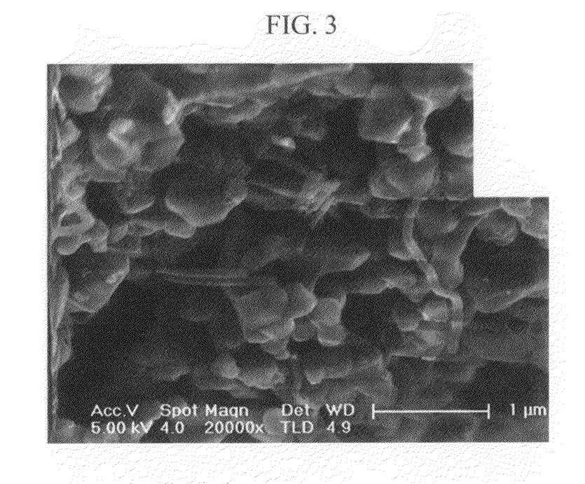

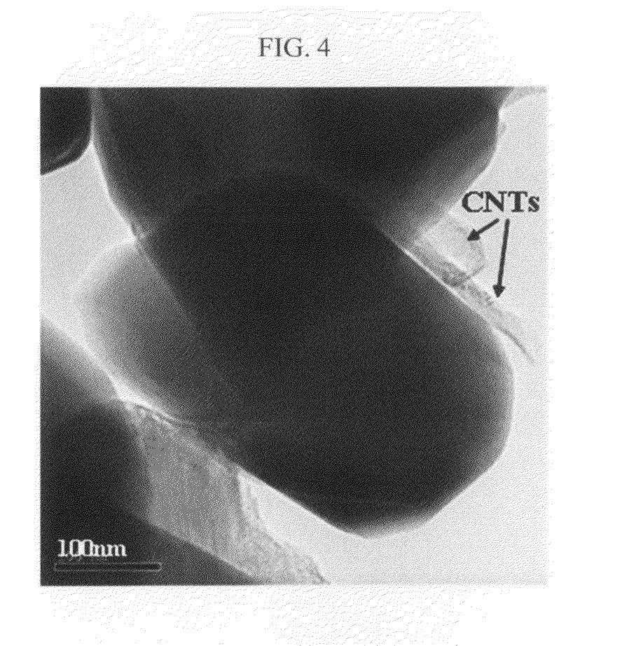

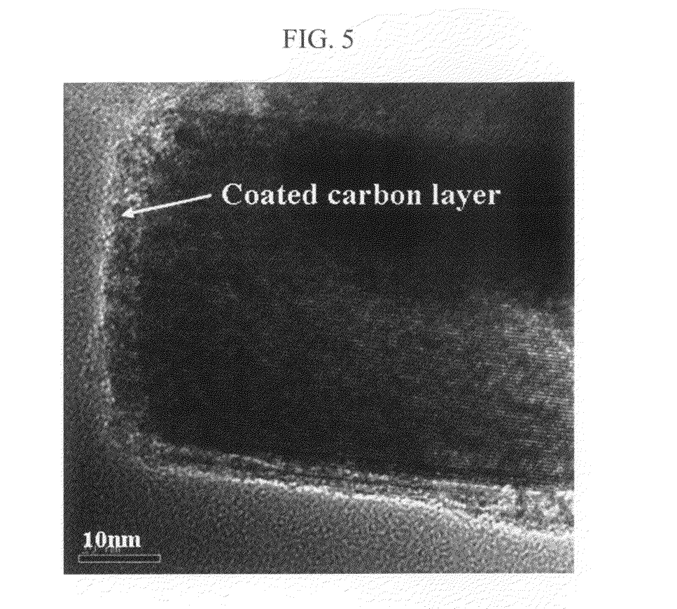

FIG. 3 shows 20,000×-enlarged SEM photograph of a negative active material constructed as Example 1. FIG. 4 shows a 250,000×-enlarged TEM photograph of the negative active material constructed as Example 1. In addition, FIG. 5 shows a 100×-enlarged SEM photograph (magnification: 2,000,000×) of the photograph shown in FIG. 3. In FIG. 4, CNT indicates carbon nanotube.

As shown in FIG. 3, the negative active material according to Example 1 included carbon nanotube, fiber-type carbon, among LTO (LiₓTi_{y}O_{Z}) particles having a carbon coating layer. In addition, as shown in FIGS. 4 and 5, each LTO particle included a very thin carbon coating layer on the surface and CNT around the carbon coating layer.

### Output Characteristics

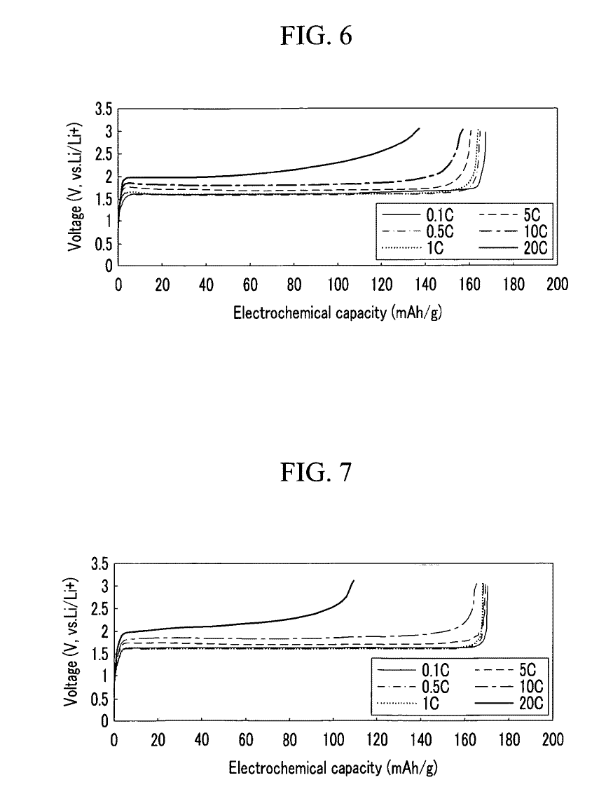

Lithium half-cells including the negative active materials constructed as Example 1 and Comparative Example 1 were once charged and discharged at a rate of 0.1 C, 0.5 C, 1 C, 2 C, 10 C, and 20 C, and their charge and discharge characteristics were measured. The results are respectively illustrated by FIGS. 6 and 7.

As shown in FIG. 6, the lithium half-cell including the negative active material constructed as Example 1, had better charge and discharge characteristics than the lithium half-cell including the negative active material constructed as Comparative Example 1 shown in FIG. 7. In other words, the lithium half-cell including the negative active material according to Example 1 had excellent output characteristics, improved capacity, and excellent energy density. In particular, a lithium half-cell including the negative active material constructed as Example 1 had very excellent charge and discharge characteristics at a high rate of charge and discharge.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A negative active material for a rechargeable lithium battery, the negative active material comprising a composite of
an active-material, comprising:
a core, comprising:
a compound represented by a Chemical Formula 1 LiₓTi_{y}O_{Z}, wherein 0.6≦x≦2.5, and 1.2≦y≦2.3; and
a carbon coating layer formed on the core the carbon coating layer comprising amorphous carbon; and
a crystalline carbon.

2. The negative active material of claim 1, wherein the amorphous carbon is included in an amount of about 0.1 wt % to about 2 wt % based on the entire weight of the negative active material.

3. The negative active material of claim 1, which the crystalline carbon is included in an amount ranging from about 1 wt % to about 20 wt % based on the entire weight of the negative active material.

4. The negative active material of claim 1, which the amorphous carbon and the crystalline carbon is present in a weight ratio ranging from about 1:99 to about 30:70.

5. The negative active material of claim 1, wherein the crystalline carbon is fiber-type carbon.

6. The negative active material of claim 5, wherein the fiber-type carbon is carbon nanotube, a carbon nano fiber, a vapor-grown carbon fiber, or a combination thereof.

7. The negative active material of claim 1, wherein the carbon coating layer is about 1 nm to about 20 nm thick.

8. A method of preparing the negative active material for a rechargeable lithium battery comprising:
preparing an amorphous carbon precursor liquid by adding an amorphous carbon precursor to a solvent;
adding crystalline carbon and a compound represented by a Chemical Formula LiₓTi_{y}O_{Z} to the amorphous carbon precursor liquid, wherein in the Chemical Formula, 0.6≦x≦2.5, and 1.2≦y≦2.3; and
heat-treating the mixture.

9. The method of claim 8, wherein the amorphous carbon precursor comprises citric acid, sucrose, cooking oil, cellulose acetate, polyacrylonitrile, polystyrene, phenol resin, naphthalenes, or a combination thereof.

10. The method of claim 8, wherein the crystalline carbon is fiber-type carbon.

11. The method of claim 10, wherein the fiber-type carbon is carbon nanotube, a carbon nano fiber, a vapor-grown carbon fiber, or a combination thereof.

12. The method of claim 8, wherein the heat treatment is performed at a temperature ranging from about 650° C. to about 750° C.

13. A rechargeable lithium battery, comprising:
a negative electrode, comprising:
a negative active material, comprising a composite of:
an active-material, comprising:
a core comprising a compound represented by a Chemical Formula LiₓTi_{y}O_{Z}, wherein in the Chemical Formula 1, 0.6≦x≦2.5, and 1.2≦y≦2.3; and
a carbon coating layer formed on the core; and
amorphous carbon, and
a positive electrode comprising a positive active material; and
a non-aqueous electrolyte.

14. The rechargeable lithium battery of claim 13, wherein the amorphous carbon is included in an amount of about 0.1 wt % to about 2 wt % based on the entire weight of the negative active material.

15. The rechargeable lithium battery of claim 13, which the crystalline carbon is included in an amount ranging from about 1 wt % to about 20 wt % based on the entire weight of the negative active material.

16. The rechargeable lithium battery of claim 13, which the amorphous carbon and the crystalline carbon is present in a weight ratio ranging from about 1:99 to about 30:70.

17. The rechargeable lithium battery of claim 13, wherein the crystalline carbon is fiber-type.

18. The rechargeable lithium battery of claim 17, wherein the fiber-type carbon is carbon nanotube, a carbon nano fiber, a vapor-grown carbon fiber, or a combination thereof.

19. The rechargeable lithium battery of claim 13, wherein the carbon coating layer is about 1 nm to about 20 nm thick.
